(19) United States
(12) Patent Application Publication
(10) Pub. No.: US 2026/0240136 A1
(43) Pub. Date: Aug. 20, 2026

(54) AUTOMATIC HOOK-SETTING AND FISH ALERTING ROD HOLDER WITH ADJUSTABLE SENSITIVITY

(71) Applicants: RAY GUOSHENG ZHU, REDWOOD CITY, CA (US); KEVIN P ZHU, REDWOOD CITY, CA (US)

(72) Inventors: RAY GUOSHENG ZHU, REDWOOD CITY, CA (US); KEVIN P ZHU, REDWOOD CITY, CA (US)

(21) Appl. No.: 19/540,767

(22) Filed: Feb. 15, 2026

Related U.S. Application Data
(60) Provisional application No. 63/759,245, filed on Feb. 17, 2025.
(60) Provisional application No. 63/776,125, filed on Mar. 23, 2025.
(60) Provisional application No. 63/928,728, filed on Dec. 1, 2025.
(60) Provisional application No. 63/940,521, filed on Dec. 14, 2025.

(51) Int. Cl. A01K 97/11; A01K 91/10

(52) U.S. Cl. CPC A01K 97/11; A01K 91/10

(57) ABSTRACT

An automatic hook-setting rod holder includes a base, a biased rod-receiving member, and a trigger mechanism with a leveraged sear that reduces the influence of primary biasing friction. A primary sensitivity assembly allows manual threshold adjustment through a biasing torque that offsets rod pressure. The trigger mechanism includes a multi-arm sear for hybrid triggering, which enables actuation through rod-tip deflection or a direct fishing line pull at various leverage ratios. Sensitivity is further adjustable by longitudinally repositioning the fishing rod to vary the torque applied to the trigger relative to a fixed fulcrum. The rod-receiving member includes a retention section that functions as the fixed fulcrum to amplify rod deflection while preventing rod ejection. The sensitivity assembly also includes a lockout state for converting the device into a stationary rod holder.

### CROSS-REFERENCE TO RELATED APPLICATIONS

This application claims the benefit of and priority to the following U.S. Provisional Patent Applications: No. 63/759,245, filed Feb. 17, 2025. No. 63/776,125, filed Mar. 23, 2025. No. 63/928,728, filed Dec. 1, 2025. No. 63/940,521, filed Dec. 14, 2025.

### FIELD OF THE INVENTION

The present invention relates generally to fishing equipment and hook-setting devices. More particularly, the invention relates to an automatic hook-setting rod holder having a sensitivity adjustment mechanism configured to offset rod pressure via a counteracting input, and which further functions as a multi-mode device capable of static rod holding and electronic fish alerting.

### BACKGROUND OF THE INVENTION

The sport of fishing often requires immediate mechanical action to set a hook once a fish has struck a bait or lure. To assist with this, various automatic hook-setting devices have been developed to improve catch rates and allow anglers to manage multiple lines simultaneously.

The majority of conventional automatic hook-setters are line-triggered, requiring the fishing line to be looped around a specialized trigger arm. These systems are prone to tangling, are difficult to set in windy conditions, and often interfere with the angler's ability to “feel” the line during retrieval. A smaller subset of devices utilizes rod-deflection triggers, which are activated by the physical bending of the fishing rod itself. However, these deflection-based systems typically suffer from a significant mechanical drawback: force dependency.

In most rod-deflection prior art, the primary spring providing the hook-setting power also generates the high frictional force that holds the trigger latch in place. Because these systems lack a mechanism to mitigate this friction, any sensitivity “adjustment” is typically limited to two flawed methods: (1) Reducing Sear Engagement: Users must barely engage the latch edge to reduce friction, resulting in dangerous, unstable “hair-trigger” states that can discharge prematurely due to wind or wave action; or (2) Opposing the Primary Force: Adjustments attempt to mechanically fight the primary biasing friction. Consequently, a “heavy” setting requires a massive amount of fish-driven force to trigger, while a “light” setting becomes unreliable under high tension.

Critically, in prior art rod-deflection devices (such as U.S. Pat. No. 7,017,296B2), the primary biasing force functions as a structural prerequisite for maintaining trigger stability. In the absence of this high-tension spring, the sear arm lacks inherent stability. Consequently, sensitivity adjustment in these systems is dependent on the biasing load—attempting to counter-balance variable friction rather than independently calibrating for a fish strike. In contrast, the present invention utilizes a high-leverage geometry to render the frictional torque generated by the primary biasing force negligible. This allows the sensitivity assembly to function primarily by offsetting the force of the fishing rod, permitting the device to serve as a precise strike indicator even in the total absence of the primary hook-setting force.

There exists a need for a mechanism that provides precision adjustment by balancing the static force of the rod and reel, allowing the user to set the release threshold by calibrating a counteracting input without interference from the primary hook-setting power.

Furthermore, existing rod-deflection holders are often cumbersome to load. Because the rod must be forced into the trigger mechanism against the main spring, there is a high risk of accidental discharge during setup. Additionally, most of these devices are specialized tools that cannot safely function as standard, static rod holders, requiring the angler to carry separate equipment for non-automatic fishing.

Therefore, there is a distinct need for a hook-setting rod holder that utilizes rod deflection but effectively manages the hook-setting force to prevent it from interfering with trigger sensitivity. Specifically, there is a need for a mechanism where the frictional interference is minimized via mechanical advantage, allowing for a sensitivity setting that purely offsets the rod's pressure, and a design that allows the device to be safely locked into a static holder mode.

### SUMMARY OF THE INVENTION

The present invention provides an automatic hook-setting rod holder featuring a trigger architecture that optimizes sensitivity by utilizing force balancing. The device generally comprises a base and a rod-receiving member 104 pivotally mounted thereto, biased by a high-tension primary spring 105 toward a released position. The rod-receiving member 104 is maintained in a cocked position by a trigger mechanism comprising a latch bar 101 and a leveraged sear 201.

A central technical advancement of the invention is the sensitivity adjustment assembly 109, designed to precisely offset the specific rod pressure (force) applied to the trigger. Unlike prior art devices where trigger sensitivity is heavily influenced by the internal friction of the main spring 105, the present invention utilizes a high-leverage sear geometry. This geometry reduces the effective torque generated by the primary hook-setting friction is substantially reduced in influence relative to the trigger sensitivity. Consequently, the sensitivity adjustment 109 does not need to overcome high internal friction; rather, it applies a calibrated counteracting input directly opposing the force generated by the fishing rod's weight. This allows the user to “balance” the rod's pressure to a hair-trigger threshold, regardless of how powerful the primary hook-setting spring 105 is set.

The trigger mechanism further incorporates a leveraged sear 201 design. This design minimizes the influence of the friction generated by the primary biasing member 105. By utilizing a high mechanical advantage, the sear 201 ensures that the internal friction is substantially reduced in influence relative to the trigger sensitivity. Consequently, the sensitivity adjustment 109 acts directly against the sear arm to set a precise threshold based solely on the rod, reel, and target species. Because the primary biasing force is not a structural prerequisite for the trigger's stability, the sensitivity assembly 109 remains functional even without the main spring 105, allowing for calibration where the trigger threshold is set without regard to the load.

In addition to the spring-based adjustment, the invention features a geometric sensitivity mechanism based on variable leverage. The rod-receiving member 104 is configured to support the fishing rod at varying longitudinal positions relative to the trigger. By sliding the rod forward or backward within the receiving cavity, the user alters the distance between the rod's center of gravity and the fulcrum point. This effectively changes the moment arm of the rod's weight, allowing the user to tune the trigger threshold by manipulating torque rather than spring tension. This method is supported by a versatile retention geometry-ranging from a narrowed snap-fit opening to a fully closed tubular perimeter-that acts as the fulcrum while preventing rod ejection.

Furthermore, in at least one embodiment, the invention utilizes the physical geometry of the rod-receiving member 104 to provide mechanical advantage and maintain structural alignment. The proximal end of the member features a narrowed opening acting as a fixed fulcrum to provide a pivot point for the rod handle. In certain embodiments, this opening is configured to constrain the rod's axis of rotation, utilizing specific geometry (such as a slot or notch) to maintain the reel orientation—whether for spinning, baitcasting, or other reel types. By preventing the rod from twisting, the opening ensures that the rod's center of gravity remains aligned longitudinally with the actuator interface 107. This geometry ensures that the energy from a fish strike is amplified and translated efficiently into the trigger vector.

Finally, the device offers multi-mode utility derived from the absence of the primary force prerequisite. Unlike prior art that fails without the main spring, the present invention can function as a standalone, high-precision strike indicator even in the total absence of the primary hook-setting force. Additionally, the device supports a lockout mode; by advancing the sensitivity adjustment member 109 to a hard stop, the latch becomes immobilized, converting the unit into a stationary rod holder for standard fishing.

### OBJECTS OF THE INVENTION

In view of the limitations of prior art hook-setting devices, the following are the primary objects of the present invention:
To provide a hook-setting rod holder with precision force balancing: It is an object of the invention to provide a trigger mechanism wherein the force required to trigger the device is set by the user substantially independently of the primary hook-setting spring tension, allowing for maximum setting power without sacrificing light-strike sensitivity.
To provide geometric sensitivity calibration: It is an object of the invention to enable sensitivity adjustment via the relative longitudinal positioning of the fishing rod and the actuator interface. By altering the distance between the rod's center of gravity and the fulcrum—either by sliding the rod or moving the trigger mechanism—the user can utilize the rod's own mass as a variable tuning parameter to set the trigger threshold.
To align adjustment with rod pressure: It is an object of the invention to provide a sensitivity adjustment assembly that operates by balancing the force of the rod, matching the natural downward deflection of a fishing rod during a strike, thereby ensuring precise and predictable trigger thresholds.
To utilize mechanical advantage for friction management: It is an object of the invention to provide a trigger mechanism wherein the latch geometry minimizes the influence of the frictional force of the primary biasing element, preventing the adjustment mechanism from having to oppose or “fight” the main spring friction.
To provide mechanical advantage via a leveraged sear: It is an object of the invention to utilize a high-leverage sear design that converts a light vertical rod force into a low-torque rotation.

This effectively substantially reduces the influence of internal friction, ensuring that adjustment inputs act directly on the release threshold.
To maximize rod deflection and alignment via a fixed fulcrum: It is an object of the invention to incorporate a narrowed proximal opening in the rod-receiving member that acts as a fixed fulcrum while constraining rod rotation. This ensures that the rod handle functions as an efficient lever and that the rod's center of gravity remains aligned longitudinally with the actuator interface.
To provide a versatile multi-mode device: It is an object of the invention to provide a sensitivity assembly that functions effectively independently of the primary spring, allowing the device to operate as a precise strike indicator even in the absence of the hook-setting force.

Additionally, the assembly includes a lockout state, allowing the user to quickly convert the automatic hook-setting rod holder into a stationary rod holder for safe transport or non-automatic fishing.
To accommodate equipment variables: It is an object of the invention to allow the user to precisely set the trigger threshold to account for the specific weight of different rods, reels, and the resistance of various target species.

### BRIEF DESCRIPTION OF THE DRAWINGS

FIG. 1 is a side elevation view of the preferred embodiment of the automatic hook-setting rod holder in the released position, identifying primary components including the base assembly featuring a stationary latch bar 101, the pivotable rod-receiving member 104, the primary pivot 103, and the primary biasing element 105.

FIG. 2 is a detailed perspective view of the leveraged sear 201, illustrating the integrated monolithic structure of the sear engagement interface 202 and the actuator interface 107 used to translate vertical rod deflection into rotational movement.

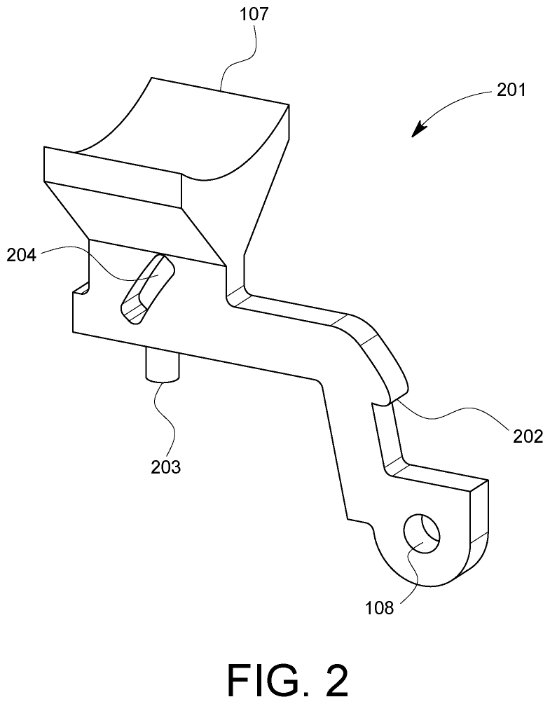

FIG. 3 is a longitudinal cross-sectional view of the trigger mechanism in the cocked position, illustrating the stationary placement of the trigger mechanism within the latch bar 101 of the base assembly and the relationship between the primary frictional force and the counteracting input applied by the sensitivity assembly 109.

FIG. 4 is a perspective view of the latch bar 101 of the base assembly with the rod-receiving member 104 removed, revealing the internal pivot points of the sear 201, the integrated actuator interface 107, and the seating for the sensitivity adjustment member 109.

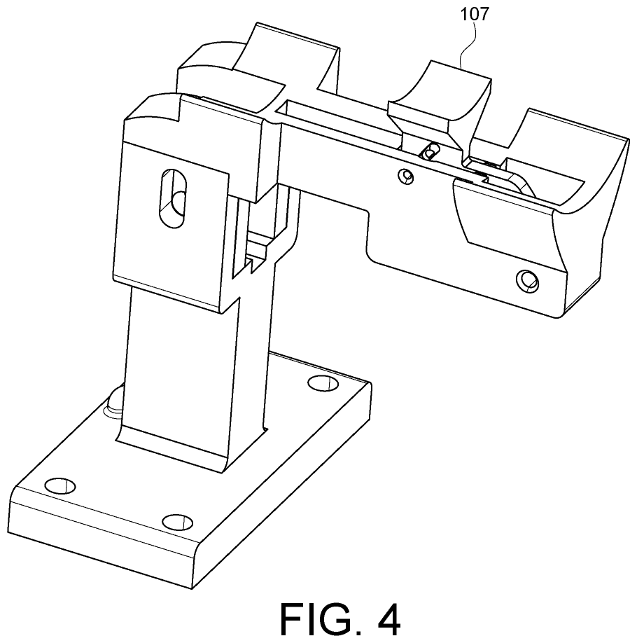

FIG. 5 is an operational diagram illustrating the hook-setting trajectory during a strike event, depicting the path of travel from the cocked (horizontal) position to the released (upright) position.

FIG. 6 is a right-side perspective view of the apparatus in the cocked position. This view specifically illustrates the narrowed opening located on the top surface of the proximal (rear) section of the rod-receiving member 104. The figure further illustrates a longitudinal positioning constraint 601 (depicted here as a resilient band, though mechanical clamps or collars are contemplated). These features cooperate to act as a fixed fulcrum and rotational constraint, capturing the rod handle to ensure the rod's center of gravity remains aligned with the actuator interface 107 during a strike.

FIG. 7 is a left-side perspective view of the cocked apparatus, illustrating the external housing, the integrated accessory attachment points (or “ears”) for securing bells or straps, and the user-accessible interface of the sensitivity adjustment assembly 109.

FIG. 8 is a side elevation view of an alternative embodiment featuring a separate trigger cradle 801 and an external sear arm 804, illustrating the adaptability of the trigger logic to different mechanical form factors. This view depicts a trigger cradle 801 configured to pivot independently of the rod-receiving member 104—either by sharing a common pivot axis or via an independent mounting point 802—to actuate the sear arm 804 without requiring disassembly of the primary biasing element 105. The figure further illustrates the positioning of an electronic sensor, such as a limit switch 805, configured to detect rotation of the trigger mechanism to provide a strike alert in both a biased hook-setting mode and a decoupled alert-only mode.

FIG. 9 is a perspective view of the alternative embodiment of FIG. 8 mounted on a support structure with a fishing rod installed, illustrating the engagement of the rod handle with the external trigger cradle 801.

FIG. 10 is a detailed perspective view of the mounting stem 102 and pivot joint, showing the interlocking radial face splines, the load-isolating compression bushing, and tilt-adjustment features that allow for incremental angular positioning of the device relative to the base.

FIG. 11 is a bottom perspective view of the apparatus, specifically illustrating the universal mounting interface located at the base of the stem 102. This view details the single-bolt slotted assembly configured to secure the device to varied supports, such as bucket lids, camera tripods, or clamp fixtures, utilizing either a top-down or bottom-up fastening orientation.

FIG. 12A is a composite view illustrating the multi-arm sear embodiment. The left panel shows the assembled apparatus with the secondary sear arm extending downward. The right panel is a detailed isolation view of the multi-arm sear, identifying the primary actuator pad 107, the secondary vertical arm, the auxiliary biasing anchor 1203 featuring an aperture for tension or compression-based adjustment, and the terminal extension adapter ring 1204.

FIG. 12B is a side perspective view of the apparatus with a modular extension arm installed. This view illustrates how a distinct sear extension component 1205 engages the adapter ring 1204, providing a plurality of notched attachment points for fishing lines to adjust leverage and sensitivity.

### DETAILED DESCRIPTION OF THE PREFERRED EMBODIMENTS

### Overview of the Apparatus

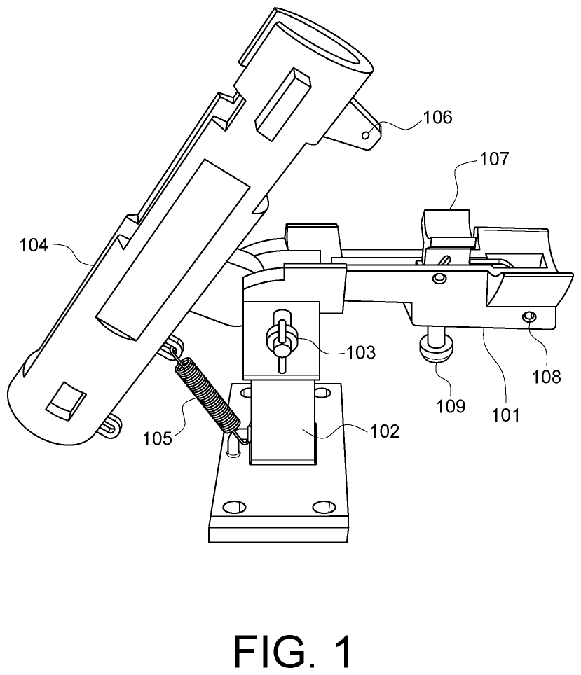

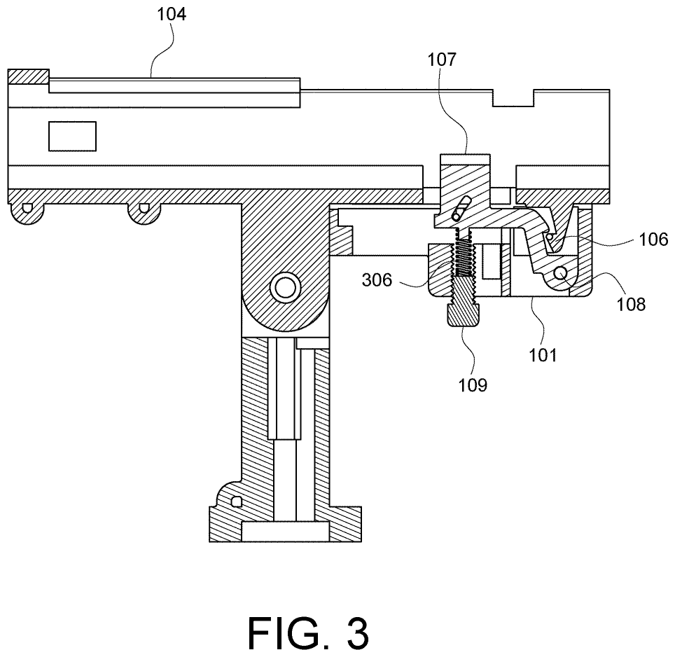

Referring to FIG. 1 and FIG. 3, the present invention comprises an automatic hook-setting and fish alerting apparatus configured to hold a fishing rod and automatically pivot said rod upward upon detection of a fish strike. The apparatus is generally comprised of a base assembly, a rod-receiving member 104, and a trigger mechanism. It is noted that the rod-receiving member 104 is labeled as ‘Tube’ in the accompanying drawings (e.g., FIG. 1) and is periodically referred to herein as the ‘tube’. These terms are used interchangeably to denote the component configured to support the fishing rod, and the invention is not limited to a strictly tubular geometry. The base assembly includes a stem 102 adapted for mounting to a support surface—such as a bucket, dock, boat gunwale, or a stake driven into the ground-and a latch bar 101 extending horizontally therefrom, coupled via a shared primary pivot axis 103.

It should be noted that while the terms ‘vertical’ and ‘horizontal’ are used herein to describe the preferred orientation, these terms refer to the force vectors relative to the longitudinal axis of the rod-receiving member 104. The invention functions identically regardless of the absolute mounting angle relative to the ground.

### Layered Structural Architecture

In certain embodiments, the apparatus comprises a plurality of stacked or layered members arranged along a common axis, including a rod-supporting member, a trigger member, and a biasing member. These members are configured to permit relative rotation with respect to one another about a shared primary pivot axis 103 while remaining structurally coupled. This layered arrangement allows the primary biasing load, trigger stability, and sensitivity adjustment functions to be structurally isolated from one another, thereby facilitating independent calibration, improved safety during loading, and modular adaptation of individual components without affecting the operation of the remaining layers.

### Structural Assembly and Angular Adjustment

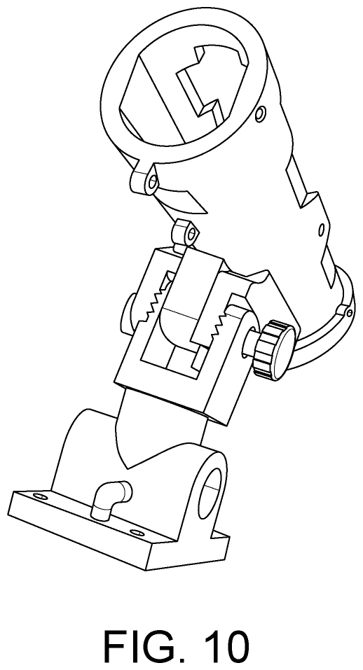

Referring specifically to FIG. 10, the connection between the stem 102 of the base assembly and the latch bar 101 incorporates a rigid angular adjustment assembly. This assembly comprises mating interlocking radial face splines configured to allow the user to incrementally adjust the angle of the latch bar 101 relative to the stem 102. Unlike friction-based ball joints which may slip under the high torque of a hook set, these splines provide a positive mechanical lock at discrete angles. Crucially, this assembly utilizes a load-isolating compression sleeve (or bushing) positioned coaxially within the pivot joint. This sleeve is configured with a width dimension slightly greater than the width of the pivoting portion of the rod-receiving member 104. Consequently, when the user tightens the assembly to lock the angle of the stem 102 and latch bar 101, the compressive clamping force is applied solely to the sleeve. This isolates the rod-receiving member 104 from the clamping force, allowing it to rotate freely relative to the latch bar 101 upon release, regardless of how tightly the mounting angle is secured.

Importantly, angular adjustment of the rod-receiving member 104 relative to the base assembly is independent of trigger sensitivity and does not alter the release threshold of the trigger mechanism, which is governed solely by the sensitivity adjustment assembly 109 and/or geometric leverage relationships described herein.

### The Trigger Mechanism and Force Balancing

As detailed in the cross-sectional view of FIG. 3, the core of the invention is the trigger mechanism, which governs the release of the rod-receiving member 104. The mechanism comprises a latch—specifically a pivotable sear 201—and an actuator interface 107. In the preferred embodiment, these components are integrated into a monolithic unitary member pivotally mounted within the latch bar 101. The trigger mechanism further incorporates a leveraged sear 201 design. This design minimizes the influence of the horizontal friction generated by the primary biasing member 105. By utilizing a high mechanical advantage, the sear 201 ensures that the internal friction has nearly no interference on the trigger sensitivity. Consequently, the sensitivity adjustment 109 acts directly against the sear arm to set a precise threshold based solely on the rod, reel, and target species, rather than compensating for variable internal friction.

### Detailed Description: Precision Force-Balancing Architecture

The trigger mechanism operates through a precision force-balancing architecture. When the apparatus is in the cocked position, the primary biasing element 105 exerts a significant force on the latching pin 106. However, the latch (sear 201) is configured with a high mechanical advantage, defined by a specific ratio between the actuator lever arm and the latching lever arm.

Specifically, the sensitivity adjustment assembly 109 utilizes an adjustment spring 306 to apply an adjustable counteracting input at a first radial distance from the sear pivot axis 108. The sear 201 includes a biasing element anchor 203 for receiving the counteracting input. Conversely, the frictional torque generated by the primary biasing element 105 acts upon the sear engagement interface 202 at a second radial distance from the sear pivot axis 108.

By configuring the first radial distance to be greater than the second radial distance, the mechanism achieves a mechanical gain that materially reduces the influence of the internal frictional torque relative to the actuation and adjustment forces. This high-leverage geometry effectively mitigates the interference of the main spring tension on trigger sensitivity.

Specifically, the ratio between the actuator lever arm and the latching lever arm is selected such that the frictional torque does not proportionally increase the trigger threshold relative to the primary spring tension. This ensures that as the primary hook-setting force is increased, the release threshold remains governed by the user-calibrated counteracting input rather than becoming progressively “heavier” due to internal friction. With internal friction effectively managed and the force dependency decoupled, the sensitivity adjustment assembly 109 functions primarily to apply a controllable counteracting input that balances the static weight of the fishing rod.

With internal friction effectively minimized, the sensitivity adjustment assembly 109 functions solely to apply a controllable counteracting input that supports the weight of the fishing rod. By rotating the threaded adjustment member, the user varies this counteracting input until it reaches a state of equilibrium, just barely offsetting the rod pressure.

In this balanced state, the rod is maintained at a “hair-trigger” threshold. A fish strike then adds a strike force to the rod tip, tipping the mechanical balance and instantly releasing the latch regardless of the magnitude of the primary hook-setting force.

### Alternative Biasing Elements

Although certain embodiments utilize mechanical springs as biasing elements, the sensitivity adjustment assembly 109 and/or trigger mechanism may alternatively employ elastomeric members, rubber bands, compliant polymer elements, magnetic biasing assemblies, or hybrid combinations thereof. Such biasing elements may be selected to provide desired force-displacement characteristics, environmental resistance, cost advantages, or non-contact operation, without departing from the functional principles of the invention.

### Trigger Mechanism Variants

While the preferred embodiments describe a pivotable sear 201 and actuator interface 107, the invention is not limited to any particular latch construction. Suitable trigger mechanisms may include, without limitation, commercially available push-push latches, cabinet latches, glove-box latches, friction-based detents, cam locks, or other releasable retention mechanisms capable of maintaining the rod-receiving member 104 in a cocked position and releasing in response to a force applied by the fishing rod. Such mechanisms may rely on frictional engagement, geometric interference, spring bias, or combinations thereof.

Trigger mechanisms may further include spring-loaded plungers, index detents, or arrays of resilient contact members configured to resist downward rod deflection until a threshold is exceeded, thereby functioning as a non-latching trigger for strike detection.

### Multi-Arm Sear and Kinematic Versatility

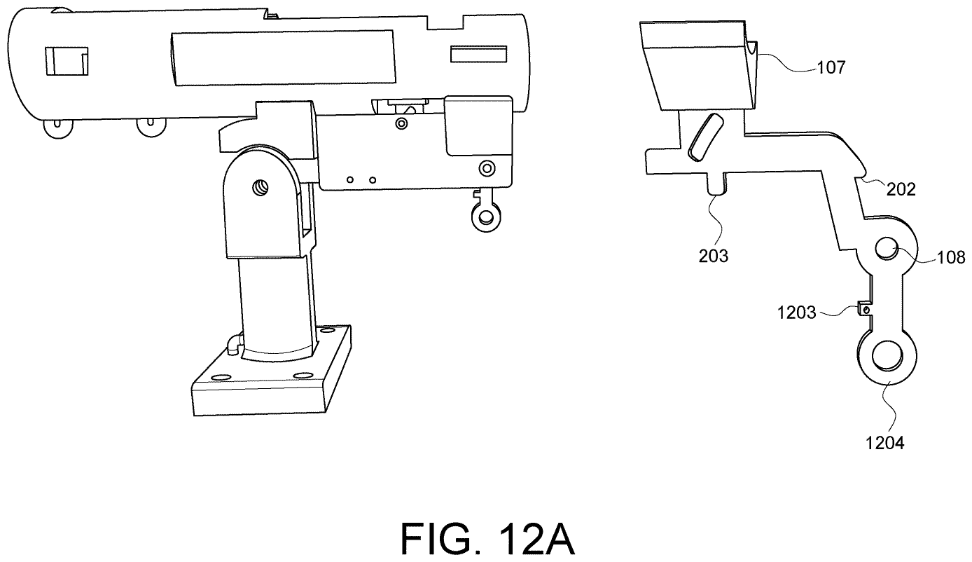

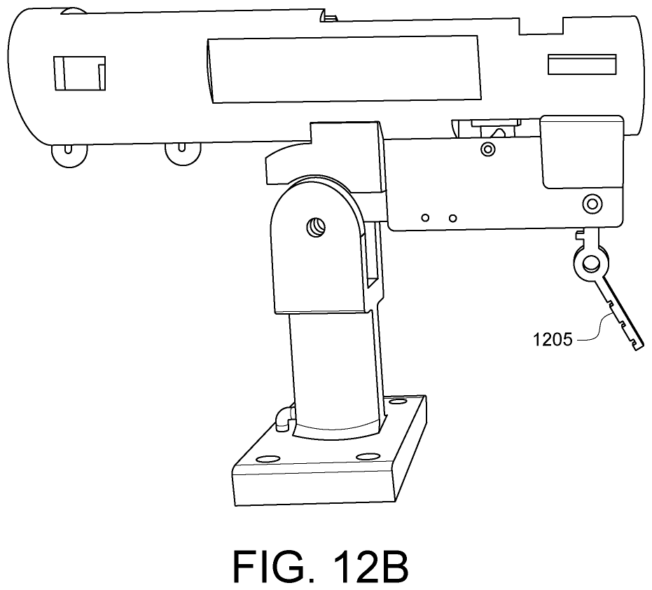

Referring to FIG. 12A and FIG. 12B, the invention contemplates a multi-arm sear configuration designed to maximize adaptability. As shown in the isolation view of FIG. 12A, the sear 201 is not limited to a single horizontal lever but may comprise a vertical or secondary arm extending from the pivot bore 108. The invention explicitly contemplates that any arm or combination of arms may be utilized for either triggering or sensitivity adjustment.

A critical feature of this multi-arm configuration is the auxiliary biasing anchor 1203. Unlike the primary adjustment which typically utilizes a compression spring pushing upward against the horizontal arm, anchor 1203 is depicted with a transverse aperture or eyelet. This geometry enables the application of the counteracting input via various force vectors, including tension (pulling) or compression (pushing). Depending on the arm's orientation relative to the pivot and the nature of the biasing element (e.g., spring, rubber band), the sensitivity adjustment mechanism 109 can be oriented in various spatial configurations—such as horizontally, vertically, or at oblique angles—to generate the required counter-torque. This ensures that the sensitivity adjustment interface can be positioned on the side, rear, or bottom of the housing to accommodate different ergonomic requirements or to facilitate the “flipping” of the sear component.

Hybrid Triggering and Variable Leverage: The secondary arm is configured to provide a hybrid triggering capability, allowing actuation via rod deflection or direct line pull. In one embodiment (as shown in FIG. 12B), this is achieved via a modular system where the secondary arm terminates in a trigger arm extension adapter 1204 (e.g., a ring) that receives a detachable sear extension arm 1205.

However, the invention explicitly contemplates integral embodiments wherein the “extension” is not a separate component but is formed as a unitary, elongated portion of the secondary arm itself. In either the modular or integral configuration, this arm structure comprises a plurality of attachment points (such as notches, holes, or ridges) spaced at varying radial distances from the sear pivot axis 108.

These variable attachment points allow the user to mechanically “tune” the gain ratio. Attaching a trigger line to a point distal from the pivot increases leverage (high sensitivity), while attaching to a point proximal to the pivot reduces leverage (low sensitivity). Thus, the “sear extension” refers to the functional geometry providing these leverage points, whether constructed as a detachable accessory or a permanent feature of the sear's monolithic casting. The hybrid triggering capability of the secondary arm is particularly advantageous in shore fishing applications where the rod is oriented substantially horizontally. In such configurations, the vertical torque generated by rod-tip deflection may be limited. By utilizing the secondary arm as a line-trigger interface, the device can be triggered by a near-horizontal line pull while the rod-receiving member 104 remains in a horizontal orientation, thereby preserving the full retraction arc of the primary biasing element 105 for a high-velocity hook set.

### Environmental Hardening and Drainage

To ensure reliable operation in freezing conditions (e.g., ice fishing) or marine environments, the apparatus acts to prevent immobilization of the trigger mechanism due to ice formation. The rod-receiving member 104 and base assembly may incorporate drainage apertures strategically positioned adjacent to the latch, sear 201, and actuator interface 107 to allow water to evacuate rather than pooling and freezing. Additionally, the trigger assembly may be constructed with tolerances or hydrophobic coatings that resist ice adhesion, while any electronic alert components are potted or sealed within a waterproof enclosure to withstand moisture and sub-freezing temperatures.

### Rod Retention and Fixed Fulcrum Dynamics

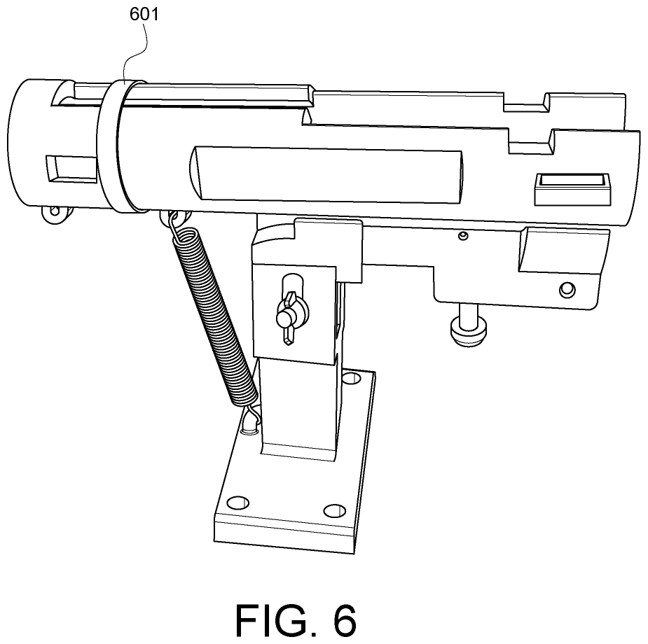

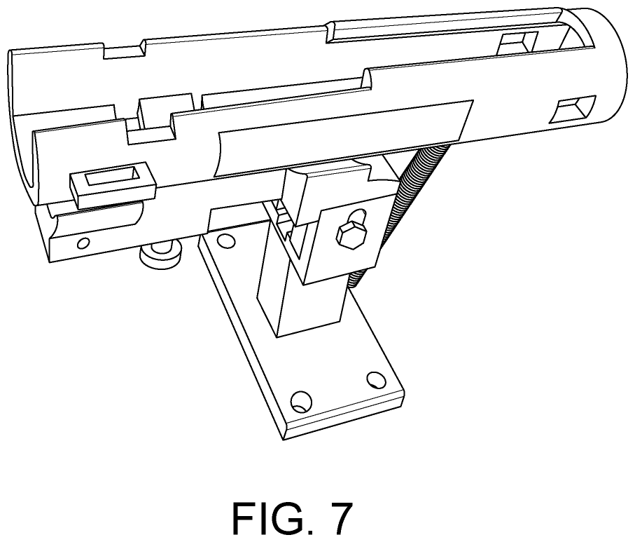

Referring to FIG. 6 and FIG. 7, the rod-receiving member 104 features a top longitudinal opening. A key feature of this embodiment is that the opening is narrowed at the proximal end (rear) of the tube to a width less than the standard diameter of a fishing rod handle. This configuration creates an interference snap-fit that securely retains the fishing rod, preventing it from being ejected during the high-velocity hook-setting motion. The interior surface of the receiving cavity may optionally be lined with a compliant material, such as rubber, foam, or a polymer coating, to enhance grip and prevent abrasion of the fishing rod handle. Additionally, this positive retention feature facilitates single-handed operation. Once the rod handle is snapped into the narrowed opening, it is held self-supported, allowing the angler to use a single hand to pivot the rod-receiving member 104 and engage the latch without needing to manually stabilize the rod against the spring tension.

As illustrated in FIG. 7, the rod-receiving member 104 further comprises external attachment points or “ears” located on the housing. These features serve as universal mounting interfaces, allowing the user to attach auxiliary accessories such as clip-on fishing bells for auditory alerts or additional safety straps for rough water conditions. Furthermore, this narrowed proximal end establishes a fixed fulcrum point. When a fish strikes, the fishing rod handle is confined at the rear of the tube. Consequently, a downward deflection of the rod tip causes the rod to act as a first-class lever against this fixed fulcrum, amplifying the downward force applied to the actuator interface 107 located distal to the fulcrum. This mechanical advantage allows the device to detect subtle strikes (“nibbles”) and translate them into sufficient force to disengage the latch.

### Operational Sequence

A. Set State: As shown in FIG. 6, the user pivots the rod-receiving member 104 downward into a horizontal position. The sear engagement interface 202 catches the latching pin 106. The primary biasing element 105 is extended, storing potential energy.

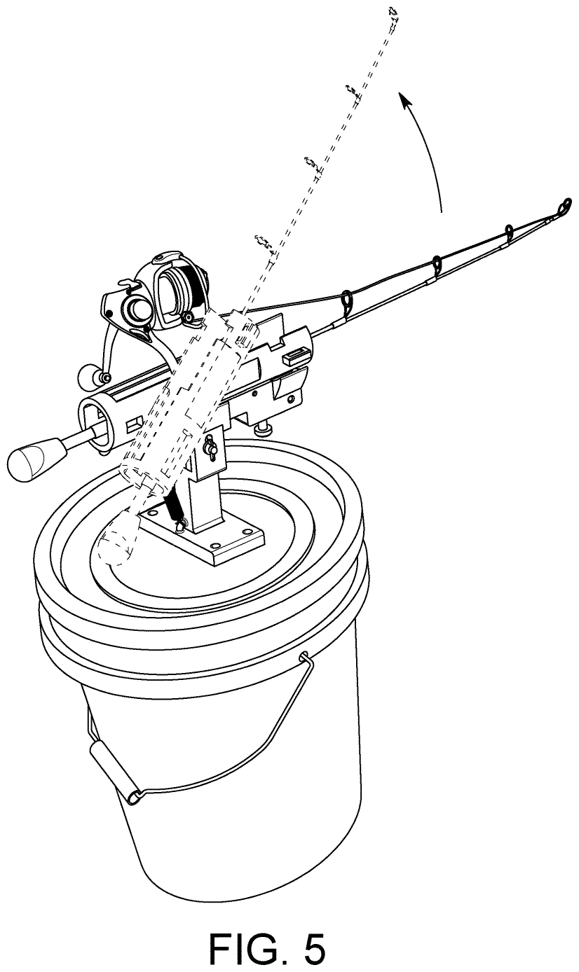

B. Triggering Event: As illustrated in FIG. 5, a fish strike pulls the rod tip downward. The rod handle pivots inside the tube and presses downward against the actuator interface 107 extending into the tube's interior. This pressure causes the rigidly coupled latch member within the latch bar 101 to pivot, overcoming the counter-torque and releasing the rod-receiving member 104.

C. Release: The sear 201 pivots, with its rotation guided or constrained by a motion-limiting slot 204, until it disengages from the latching pin 106. The primary biasing element 105 instantly retracts, swinging the rod-receiving member 104 upward to set the hook.

### Safety Lockout and Multi-Mode Functionality

The sensitivity adjustment assembly 109 provides a safety lockout configuration. By advancing the adjustment member to its maximum limit, the adjustment spring 306 is fully compressed or the adjustment member physically contacts the latch, creating a rigid obstruction. In this state, the latch is immobilized, converting the automatic hook-setting rod holder into a static rod holder safe for transport or conventional fishing methods. Additionally, in an alternative configuration, a distinct binary safety mechanism, such as a spring-loaded index plunger or a removable locking pin, may be utilized. This blocking member is configured to be manually moved between a disengaged position and an engaged position to physically immobilize the trigger mechanism. For example, the blocking member may pass through a portion of the latch bar 101 and a corresponding aperture in the rod-receiving member 104, creating a positive mechanical stop that prevents the rod-receiving member 104 from pivoting regardless of trigger input. This lockout state is functionally distinct from sensitivity adjustment 109 and is configured to convert the device into a static holder safe for transport or non-automatic fishing.

The lockout state is functionally distinct from sensitivity adjustment and is configured to prevent release of the latch regardless of trigger input, rather than merely increasing a trigger threshold.

### Electronic Alert and “Alert-Only” Mode

In any of the described embodiments, the invention may further incorporate an electronic alert system. This system comprises a sensor—such as a mechanical limit switch 805, a magnetic Hall effect sensor, or an optical interrupter—positioned to detect the actuation of the trigger mechanism. Upon a strike, the triggering motion completes a circuit to activate an audible alarm, light, or wireless signal. This alert system is configured to provide a strike notification during standard biased operation or, alternatively, the hook-setting rod holder is further configurable to an “Alert-Only” mode. By detaching or removing the primary biasing element 105, the user eliminates the automatic hook-setting force while the device functions solely as a fish detection system. In this state, the trigger mechanism remains latched and responsive to the sensitivity adjustment assembly 109, such that a fish strike trips the trigger and activates the sensor to alert the angler, but the rod-receiving member 104 remains stationary. This mode is particularly advantageous for regulations where automatic hook-setting is restricted or when the angler prefers to set the hook manually after detection.

In an alternative alert-only embodiment, fish detection is achieved by permitting limited rotation of the rod-receiving member 104 relative to the base assembly under a controlled frictional resistance at the pivot joint. In this configuration, adjustable friction at the hub defines a threshold rotational resistance, such that a fish strike produces detectable angular movement of the rod-receiving member 104 without releasing a latch or actuating a hook-setting mechanism. Rotation of the rod-receiving member 104 may be sensed mechanically or electronically to generate an alert. This embodiment is particularly suited for applications where automatic hook-setting is not desired.

### Alternative Embodiments

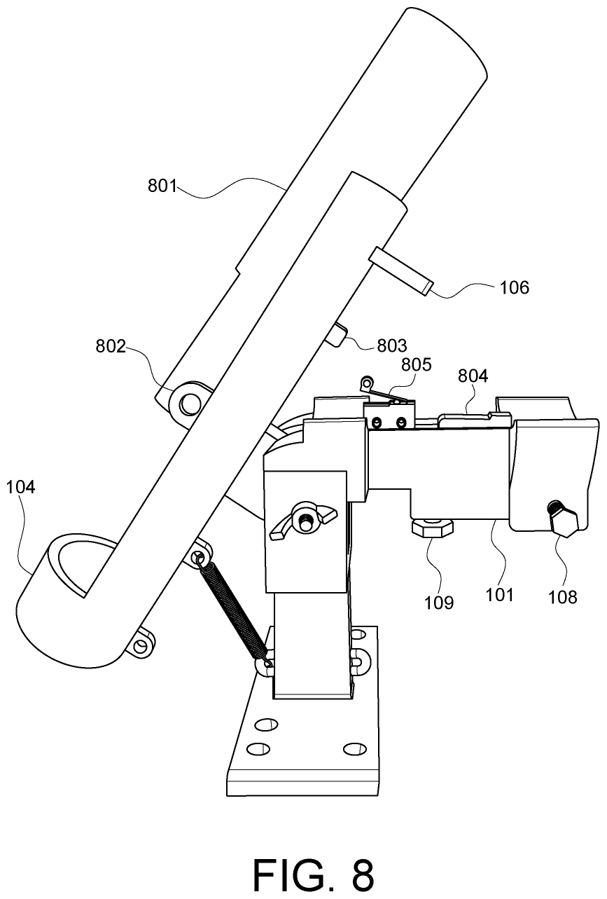

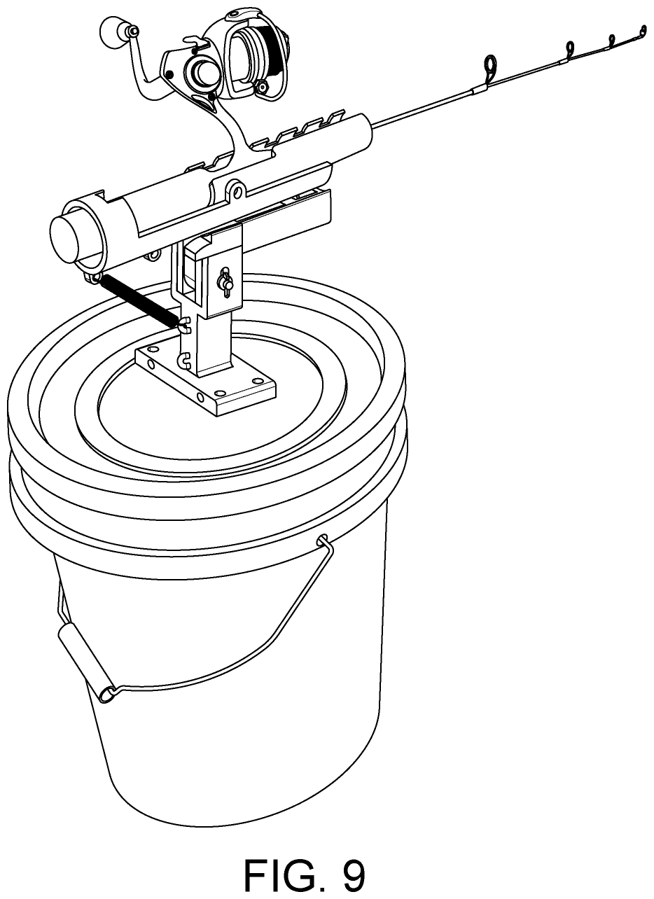

FIGS. 8 and 9 illustrate an alternative embodiment wherein the trigger mechanism is external. A trigger cradle 801 is pivotally coupled to the apparatus and pivots at a cradle pivot 802. The trigger cradle 801 includes a cradle trigger pin 803 configured to engage and actuate the sear arm 804 upon rod deflection. This configuration provides significant modularity advantages. Because the rod-receiving member 104 bears the structural load of the primary biasing element 105, the trigger cradle 801 acts as a non-load-bearing interchangeable interface. This allows the user to rapidly swap out cradles 801 of varying geometries (e.g., wide cradles for cork handles, narrow cradles for split-grips) to achieve optimal fit and trigger sensitivity without disturbing the primary hook-setting mechanism. Furthermore, the position of the cradle pivot 802 may be adjusted independently of the tube pivot, allowing for variable leverage ratios suited to specific rod lengths.

Additionally, while the preferred embodiment utilizes an adjustment spring 306 for the sensitivity adjustment, other biasing means are contemplated. For example, the sensitivity adjustment assembly 109 may comprise a plurality of magnetic elements, wherein at least one magnet is movable to vary the magnetic flux density and attractive force acting on the latch, thereby providing a non-contact adjustable biasing force.

### Longitudinal Sensitivity Adjustment and Geometric Variations

In addition to, or in lieu of, the spring-based sensitivity adjustment, the apparatus allows for sensitivity calibration via the longitudinal positioning of the fishing rod. The rod-receiving member 104 or trigger cradle 801 defines a longitudinal receiving cavity that allows the user to slide the fishing rod handle forward or backward. Sliding the rod alters the distance between the rod's center of gravity and the fulcrum point. By shifting the rod, the user changes the effective moment arm, thereby varying the static torque applied to the trigger. A rod positioned further forward (away from the fulcrum) increases the leverage of the rod's weight, exerting more force on the actuator and making the release more sensitive. Conversely, a rod positioned further backward (closer to the fulcrum) reduces this leverage, requiring a stronger strike force to trigger the mechanism (less sensitive).

It is further contemplated that the sensitivity adjustment may be achieved by kinematic inversion of the trigger mounting or the adjustment interface. In one embodiment, instead of moving the fishing rod, the actuator interface 107 (or trigger cradle 801) itself may be configured to slide or be repositioned longitudinally along the rod-receiving member 104.

Furthermore, the invention explicitly encompasses an inversion wherein the latch and sensitivity adjustment assembly 109 are mounted directly to the rod-receiving member 104 to engage a stationary catch on the base assembly. Moving the actuator interface 107 toward the fulcrum point reduces the effective lever arm of the rod's center of gravity relative to the trigger contact point, requiring greater force to actuate (lower sensitivity). Conversely, moving the actuator interface 107 away from the fulcrum increases the mechanical advantage of the rod against the trigger (higher sensitivity). Thus, the invention encompasses any adjustment that alters the relative longitudinal distance between the rod's center of gravity, the fulcrum, and the actuator interface 107, as well as any reconfiguration of the trigger housing between the stationary and pivotable components of the apparatus.

To facilitate this, the rod-receiving member 104 may incorporate a plurality of transverse notches or slots intersecting the longitudinal cavity. These notches are sized to receive the stem of the fishing reel, locking the rod at discrete, repeatable longitudinal positions corresponding to specific sensitivity levels.

Furthermore, the retention feature that establishes the fulcrum is not limited to the “proximal snap-fit” arrangement of the preferred embodiment. In alternative configurations (such as that shown in FIG. 9), the retention section may be located at the distal (front) end of the tube or extend along the entire length. Additionally, the superior opening of this retention section need not be open; it may have a width dimension of zero, constituting a closed perimeter (e.g., a complete tube or ring) through which the rod handle is axially inserted. This “closed loop” geometry provides maximum security against rod ejection while still permitting the longitudinal sliding adjustment described above.

### Longitudinal Positioning Constraint and Retention Mechanisms

In addition to the geometric retention features described above, the system may allow for—or explicitly include—a longitudinal positioning constraint 601, as generally illustrated in FIG. 6. While the sliding adjustment of the fishing rod allows for variable sensitivity tuning, it is advantageous to maintain a precise, repeatable position once the optimal sensitivity is established.

The positioning constraint is configured to restrict the longitudinal translation of the fishing rod relative to the rod-receiving member 104. This ensures that the distance between the rod's center of gravity and the fulcrum remains constant, even under wind load or during the initial moments of a strike. The invention contemplates several embodiments for this constraint:
A. External Resilient Constriction (FIG. 6 Embodiment) In one embodiment, the positioning constraint comprises a flexible, resilient member 601 disposed around the exterior of the rod-receiving member 104's proximal end. As shown in FIG. 6, this may take the form of a rubber band, O-ring, Velcro® strap, or elastic collar.

Operation: Because the proximal end of the rod-receiving member 104 features a split or open-top geometry, tightening this resilient member 601 compresses the housing walls inward against the fishing rod handle. This creates a variable friction lock that prevents the rod from sliding axially but allows for intentional adjustment by the user.

B. Integrated Mechanical Clamp In an alternative embodiment, the positioning constraint comprises a rigid mechanical clamp integrated into the rod-receiving member 104.

Cam-Lock: The housing may feature a cam-lever mechanism. When the lever is depressed, it actuates a pressure plate or biases the flexible walls of the housing inward to clamp the rod handle.

Threaded Fastener: The housing may incorporate a thumb screw or threaded knob that passes through the wall of the rod-receiving member 104 to bear against the rod handle (or a protective shim), mechanically locking the rod in place.

C. Rod-Mounted Stop Collar (“The Memory Ring”) In another embodiment, the positioning constraint is distinct from the housing and is instead attached directly to the handle of the fishing rod.

Configuration: This may comprise a split-ring, a clip-on collar, or a movable O-ring that firmly grips the rod handle.

Function: The user slides this collar along the rod handle to a specific position. When the rod is inserted into the rod-receiving member 104, the collar abuts the front or rear face of the tube (or a specific slot therein). This creates a positive mechanical stop, allowing the user to remove the rod to catch a fish and re-insert it to the exact same depth—and thus the exact same sensitivity setting—without recalibration. This embodiment satisfies the “visual reference index” requirement of the claims by physically marking the “sweet spot” on the rod itself.

D. Internal Friction Elements The rod-receiving member 104 may further comprise internal high-friction elements to act as a passive positioning constraint.

Liner: The interior surface of the receiving cavity may be lined with directional gripping material, silicone ribs, or an elastomeric sleeve that resists axial sliding of the rod unless a threshold force is applied by the user.

E. Geometric Constraint (FIG. 9) Alternatively, the positioning constraint may be integral to the housing geometry, as illustrated in FIG. 9. In this embodiment, the rod-receiving member 104 comprises a plurality of transverse notches or slots intersecting the longitudinal receiving cavity. These notches are sized to receive the stem of the fishing reel.

Function: When the reel stem is seated in a specific notch, the rod is mechanically locked against longitudinal translation (satisfying the restriction requirement).

Visual Index: The notches themselves act as the visual reference index (e.g., “Position 1,” “Position 2”), allowing the user to return to a known sensitivity setting instantly.

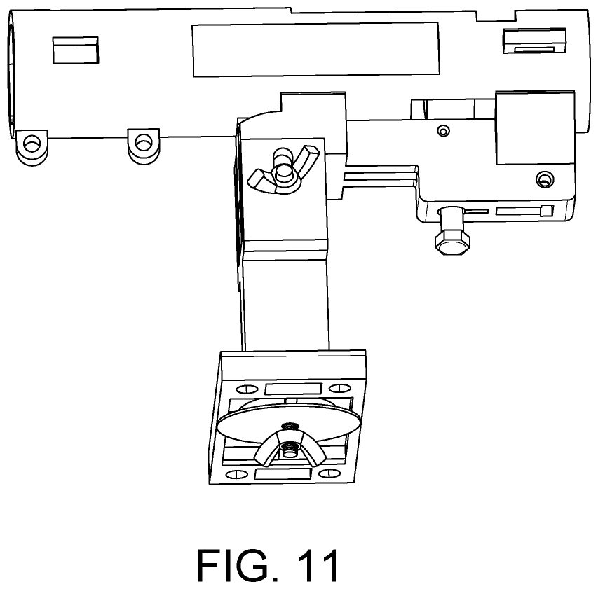

### Universal Mounting Interface (FIG. 11)

Referring to FIG. 11, the base assembly further comprises a versatile mounting interface located at the distal end of the support stem 102. Unlike localized ground stakes found in prior art, the present invention features a planar mounting flange configured with a central aperture or slot. This geometry facilitates a “single-bolt” mounting architecture, allowing the apparatus to be strictly secured to a wide variety of substrates using a single threaded fastener.

In the embodiment depicted in FIG. 11, the mounting interface is shown with a wingnut and washer assembly. It is expressly contemplated that the fastening orientation is reversible to accommodate different platforms. For example, in a “bottom-up” configuration, a bolt may pass through a substrate (such as the lid of a bucket) and into the base of the apparatus, secured by a nut housed within the stem 102 or the wingnut shown. Conversely, in a “top-down” configuration, a bolt or threaded stud may extend from the base into a receiving nut or threaded socket.

This universal interface ensures compatibility with standard equipment. For instance, the aperture may be sized to accept standard camera tripod threading or other common hardware sizes, allowing the hook-setting rod holder to be mounted directly onto tripods for use on rocky banks or ice. Alternatively, the flat flange allows for stable mating with thin-walled surfaces, such as plastic cooler lids or bucket lids, effectively turning common fishing storage containers into stable bases for the automatic hook-setter.

1. An automatic hook-setting rod holder comprising: a base assembly; a rod-receiving member pivotally coupled to the base assembly, the rod-receiving member comprising an outer wall defining a longitudinal receiving cavity configured to receive and support a handle of a fishing rod; a primary biasing element urging the rod-receiving member toward a released position; a trigger mechanism comprising a sear assembly, the sear assembly defining a latching surface and an actuator interface; wherein the actuator interface is positioned to receive, through an opening in the outer wall of the rod-receiving member, a force applied by the fishing rod in response to a strike; wherein the fishing rod is configured to pivot relative to the rod-receiving member to actuate the sear assembly while the rod-receiving member remains stationary relative to the base assembly in a cocked position against the primary biasing element; and a sensitivity adjustment assembly configured to apply an adjustable counteracting input to the sear assembly to offset force applied by the fishing rod, wherein the adjustable counteracting input establishes a release threshold of the sear assembly substantially independently of a magnitude of the primary biasing element.

2. The hook-setting rod holder of claim 1, wherein the sear assembly comprises a pivotable sear arranged about a sear pivot axis, the pivotable sear defining the latching surface and the actuator interface, wherein the actuator interface is positioned to receive the force applied by the fishing rod through the opening in the outer wall of the rod-receiving member, and wherein a mechanical advantage of the pivotable sear is defined by a ratio between a distance from the actuator interface to the sear pivot axis and a distance from the latching surface to the sear pivot axis, such that torque generated by friction associated with the primary biasing element is substantially reduced in influence relative to the release threshold.

3. The hook-setting rod holder of claim 1, wherein the primary biasing element comprises at least one of a tension spring, a torsion spring, and an elastomeric component.

4. The hook-setting rod holder of claim 1, wherein the sensitivity adjustment assembly comprises at least one resilient member selected from the group consisting of a compression spring, a tension spring, an elastomeric band, and a rubber band; and wherein the adjustable counteracting input is varied by interchanging the at least one resilient member or by manipulating an adjustment member to alter a force exerted by the at least one resilient member.

5. The hook-setting rod holder of claim 1, wherein the rod-receiving member comprises a proximal end having a top longitudinal opening with a width narrower than a diameter of the handle of the fishing rod, configured to provide an interference fit that retains the fishing rod during setting, and wherein the proximal end defines a fixed fulcrum about which the fishing rod pivots during a downward deflection, thereby creating a lever arm between the proximal end and the actuator interface that amplifies the force applied to the sear assembly to improve consistency of the release threshold.

6. The hook-setting rod holder of claim 1, wherein the actuator interface comprises a contoured pad configured to be directly contacted by-contact the fishing rod through the opening in the outer wall of the rod-receiving member when the rod-receiving member is in the cocked position.

7. The hook-setting rod holder of claim 1, wherein the base assembly comprises a stem and a latch bar, further comprising an angular adjustment assembly coupling the stem and the latch bar, the angular adjustment assembly including interlocking radial face splines configured to allow incremental angular adjustment of the latch bar relative to the stem while permitting the rod-receiving member to rotate freely relative to the latch bar upon release.

8. The hook-setting rod holder of claim 1, wherein the sensitivity adjustment assembly comprises a plurality of magnetic elements, at least one of which is movable to vary a magnetic flux density, thereby providing an adjustable biasing force on the sear assembly.

9. The hook-setting rod holder of claim 1, further comprising an electronic alert system including a sensor configured to detect actuation of the trigger mechanism and provide an electronic alert during a strike event; wherein the hook-setting rod holder is further configurable to an alert-only mode by decoupling the primary biasing element, such that, in the absence of the primary biasing element, the trigger mechanism remains latched and responsive to the sensitivity adjustment assembly and is configured to actuate the electronic alert system without pivoting the rod-receiving member.

10. The hook-setting rod holder of claim 1, wherein the release threshold of the sear assembly is further adjustable by altering a longitudinal position of the fishing rod within the longitudinal receiving cavity relative to the actuator interface, thereby varying a distance between a center of gravity of the fishing rod and a fulcrum point of the rod-receiving member to modify a static torque applied by the fishing rod against the actuator interface.

11. The hook-setting rod holder of claim 1, further comprising a binary safety mechanism comprising a blocking member manually movable between a disengaged position and an engaged position to prevent the rod-receiving member from pivoting relative to the base assembly, thereby converting the hook-setting rod holder into a static rod holder.

12. The hook-setting rod holder of claim 1, wherein the base assembly terminates in a planar mounting flange comprising a single-fastener aperture, said single-fastener aperture configured to receive a threaded bolt in either a top-down or bottom-up orientation to secure the hook-setting rod holder to an external support structure.

13. The hook-setting rod holder of claim 1, wherein the trigger mechanism further comprises a trigger cradle pivotally coupled to the hook-setting rod holder and configured to pivot relative to the rod-receiving member;
wherein the longitudinal receiving cavity is configured to support a rearward portion of the handle of the fishing rod to establish a stationary fulcrum, while the trigger cradle is configured to support a forward portion of the fishing rod; and wherein the trigger cradle is configured to pivot relative to the rod-receiving member in response to a force applied by the fishing rod and to transfer the force through the opening to the sear assembly.

14. The hook-setting rod holder of claim 1, wherein the sear assembly comprises a multi-arm sear having a primary arm configured to receive the force from the fishing rod and a secondary arm extending from a sear pivot axis; and wherein the sensitivity adjustment assembly is configured to apply the adjustable counteracting input to any one of said arms to generate a torque that opposes the force applied by the fishing rod.

15. The hook-setting rod holder of claim 14, wherein the secondary arm comprises a biasing interface, and wherein the sensitivity adjustment assembly is configured to apply the adjustable counteracting input to said biasing interface to generate a counter-torque about the sear pivot axis.

16. The hook-setting rod holder of claim 14, wherein the secondary arm defines, either integrally or via an extension arm coupled thereto, a plurality of attachment points disposed at varying radial distances from the sear pivot axis, the attachment points being configured to engage a fishing line to actuate the sear assembly at a user-selectable leverage ratio, and wherein the primary arm remains concurrently configured to receive force from the fishing rod, such that the sear assembly is actuatable by rod-applied force at the primary arm and is additionally actuatable by line-applied force at the secondary arm.

17. A method for automatically setting a fishing hook using a biased rod holder, the method comprising: positioning a handle of a fishing rod within a rod-receiving member, wherein the rod-receiving member is maintained stationary relative to a base assembly when in a cocked position; engaging a sear assembly to hold the rod-receiving member in a the cocked position against a primary biasing force; adjusting a release threshold by applying a biasing counter-torque to the sear assembly to offset a static torque generated by the weight of the fishing rod; wherein the biasing counter-torque is applied to the sear assembly at a first radial distance from a sear pivot axis, and the primary biasing force generates a frictional torque at a latching surface located at a second radial distance from the sear pivot axis; wherein the first radial distance is greater than the second radial distance, thereby establishing a mechanical advantage that substantially reduces the influence of the frictional torque relative to the biasing counter-torque; and releasing the sear assembly via a downward deflection of the fishing rod, wherein the downward deflection applies a force to an actuator interface of the sear assembly through an opening in an outer wall of the rod-receiving member.

18. The method of claim 17, wherein the ratio of the first radial distance to the second radial distance defines a mechanical gain, and wherein the step of adjusting the release threshold further comprises manipulating an adjustment member to vary the biasing counter-torque until the sear assembly reaches a state of equilibrium where a strike force from a fish overcomes the net sum of the biasing counter-torque and the materially reduced influence of the frictional torque.

19. The method of claim 17, wherein the step of releasing the sear assembly comprises moving the fishing rod relative to the rod-receiving member to actuate the sear assembly while the rod-receiving member remains stationary relative to a the base assembly, until the release threshold is exceeded and the rod-receiving member rotates.

20. The method of claim 17, wherein releasing the sear assembly is achieved by movement of a pivotable sear of the sear assembly, the pivotable sear being rigidly coupled to the actuator interface, and wherein the movement occurs relative to a pivot axis or guide path located within the base assembly.

21. The method of claim 17, further comprising converting the biased rod holder to a static rod holder by advancing an adjustment member until the sear assembly is immobilized in a locked state.

22. The method of claim 17, wherein the actuator interface comprises a detachable trigger cradle pivotally coupled to the hook-setting rod holder and configured to pivot relative to the rod-receiving member, the method further comprising interchanging the detachable trigger cradle with a second trigger cradle of a different geometry to accommodate a different fishing rod.

23. An automatic hook-setting rod holder comprising: a base assembly; a rod-receiving member pivotally coupled to the base assembly; a primary biasing element urging the rod-receiving member toward a released position; and a sear assembly configured to releasably maintain the rod-receiving member in a cocked position, wherein the sear assembly comprises an actuator interface positioned to receive force from a fishing rod; wherein the rod-receiving member defines a longitudinal receiving cavity configured to support a handle of the fishing rod while constraining the handle against vertical disengagement during a hook-setting motion; wherein a longitudinal position of the fishing rod within the longitudinal receiving cavity establishes a moment arm between a center of gravity of the fishing rod and a fulcrum point of the rod-receiving member, such that a weight of the fishing rod produces torque about the fulcrum point; and wherein a release threshold of the sear assembly is adjustable by altering the longitudinal position of the fishing rod relative to the actuator interface, thereby varying a distance between the center of gravity of the fishing rod and the fulcrum point to vary a torque applied to the actuator interface.

24. The automatic hook-setting rod holder of claim 23, further comprising a longitudinal positioning constraint disposed on or about the handle of the fishing rod, wherein the longitudinal positioning constraint is configured to: (a) provide a visual reference index relative to the rod-receiving member for establishing a calibrated longitudinal position of the fishing rod; (b) engage the rod-receiving member to restrict longitudinal translation of the fishing rod relative to the rod-receiving member in response to external axial forces; and (c) establish a fixed fulcrum axis about which the fishing rod pivots to actuate the sear assembly, thereby maintaining a consistent lever-arm length for the release threshold of the sear assembly.

25. The automatic hook-setting rod holder of claim 23, wherein the rod-receiving member comprises a retention section that establishes the fulcrum point, said retention section having a superior opening defined by a width dimension ranging from zero, constituting a closed perimeter section, to a non-zero value less than a diameter of the fishing rod handle, such that the fishing rod handle is captivated within the retention section.

26. The automatic hook-setting rod holder of claim 23, further comprising a sensitivity adjustment assembly configured to apply an adjustable counteracting force to the sear assembly, wherein said counteracting force is configured to modulate the release threshold of the sear assembly by selectively offsetting one or more internal or external mechanical forces acting upon the sear assembly.

27. A method for calibrating a release threshold of an automatic hook-setting rod holder, the method comprising: providing a rod holder comprising a rod-receiving member pivotally coupled to a base assembly and a sear assembly having an actuator interface; positioning a handle of a fishing rod within a longitudinal cavity of the rod-receiving member such that the handle engages a fulcrum point; and adjusting the release threshold of the sear assembly by altering a longitudinal position of the fishing rod relative to the actuator interface, thereby varying a distance between a center of gravity of the fishing rod and the fulcrum point to modify a static torque applied by the fishing rod against the actuator interface.
